(19) United States
(12) Patent Application Publication
(10) Pub. No.: US 2004/0045206 A1
(43) Pub. Date: Mar. 11, 2004

(54) Advertising method for fixed bottle bottled water dispenser

(76) Inventor: James Witham, Rancho Mirage, CA (US)

Correspondence Address: Charles D. Gunter, Jr., Whitaker, Chalk, Swindle & Sawyer, LLP, 3500 City Center Tower II, 301 Commerce Street, Ft. Worth, TX, 76102, US

(21) Appl. No.: 10/241,154

(22) Filed: Sep. 11, 2002

(51) Int. Cl. G09F 3/18

(52) U.S. Cl. 40/642.02

(57) ABSTRACT

A method of providing advertising is shown which utilizes a fixed water bottle and companion stand arrangement in a bottled water dispenser system. Advertising indicia is either applied directly to an exterior surface of the bottle or is applied to a substrate which is affixed to the bottle exterior surface. The water bottle, together with its companion stand, is then distributed by a sales force to a target group of end users which group is selected based upon specific market analysis criteria. The associated stand can also have an advertising message applied to an exterior surface thereof.

### CROSS REFERENCE TO RELATED APPLICATIONS

The present application is related to the co-pending application of James Witham and Bradford Corbett, Jr. entitled “Advertising Method For Changeable Bottle Bottled Water Dispenser”, Attorney Docket No. 019296.000003, filed concurrently herewith.

### BACKGROUND OF THE INVENTION

2. Field of the Invention

The present invention relates generally to a method of providing advertising utilizing bottled water dispensers and, more specifically, utilizing a fixed water bottle and stand arrangement.

2. Background of the Invention

In traditional water dispensers, a replaceable bottle is mounted with a neck and spout downwardly extending into an opening in a ledge of a dispensing stand. The bottle is free standing and held in place by gravity. The bottles may be made of glass or may be made of plastic or other synthetic materials. The bottles are periodically picked up and taken to a central location for refilling before being returned to the end user.

In use, refillable bottles often become scratched and unsightly in appearance. It is therefore desirable, in some situations, to provide a decorative covering which at least partly covers the exterior bottle surface. Preferably, such a covering would be temporarily affixed to the bottle and therefore removable.

U.S. Pat. No. 4,834,250, to Dumbeck et al. shows a decorative protective hood for a water dispenser. In this case, the protective hood is a woven fabric, preferably of nylon, which is used to drape the water bottle and which also serves the purpose of preventing the accumulation of dirt or other contamination.

U.S. Pat. No. 5,356,046 to Burke shows another cover for a bottled water dispenser. The cover is provided in the shape of a sack which has an opening and a string for closing the opening of the sack against the neck of the water bottle. Again, the purpose of the Burke invention is to isolate the water bottle from the surrounding environment in order to decrease the chance for transmission of disease and prevent the growth of microorganisms within the water.

In a more recent bottled water distribution system, the water bottle is itself fixed to the support stand. Rather than collecting such bottles for refilling, the stand supplies filtered water on an as-needed basis to continually refill the fixed water bottle as water is dispensed by the end user. One patented system is sold by AquaCell Technologies, Inc., of Rancho Cucamonga, California, as the “PURIFIC” unit.

Despite such advances in the art, none of the above references have as an object to provide an advertising method utilizing existing bottled water dispensers, whether they be replaceable or fixed bottle bottled water dispensers.

### SUMMARY OF THE INVENTION

The method of the present invention provides an advertising technique utilizing a fixed bottle/stand water dispenser system in which the bottle/stand combination apparatus is distributed to end users by a sales force. An advertising message is applied either directly to an exterior surface of the bottle or to a suitable substrate. Where the advertising message is applied to a substrate, the substrate is preferably either a plain band such as a paper band or a shrink-wrap plastic material although other materials such as fabrics, paper and other suitable replaceable materials could be utilized as well. The substrate is then secured to an exterior surface of the water bottle which, together with its companion stand, is distributed by the sales force to a target group of end users. Preferably, the target group is selected based upon specific market analysis criteria. If desired, the stand itself can also have an advertising message applied on an exterior surface thereof, either alone or in conjunction with the labeling on the companion bottle. The stand could also feature an electronic display screen of a suitable size to display a desired advertising message.

Additional objects, features and advantages will be apparent in the written description which follows.

### BRIEF DESCRIPTION OF THE DRAWINGS

FIG. 1 shows a bottled water apparatus including a fixed water bottle labeled according to the method of the invention, the fixed bottle being supported upon a companion dispensing stand;

FIG. 2 is a schematic illustration of one step in the method of the invention in which an advertising message is applied to a substrate;

FIG. 3 is also a schematic diagram representative of the subsequent step in the method of the invention in which the substrate is a heat shrink material which is affixed to an exterior surface of the water bottle; and

FIG. 4 is a view of a point of use water dispensing apparatus having an advertising substrate applied to an upper region thereof and having an electronic display panel on a lower region hereof.

### DETAILED DESCRIPTION OF THE INVENTION

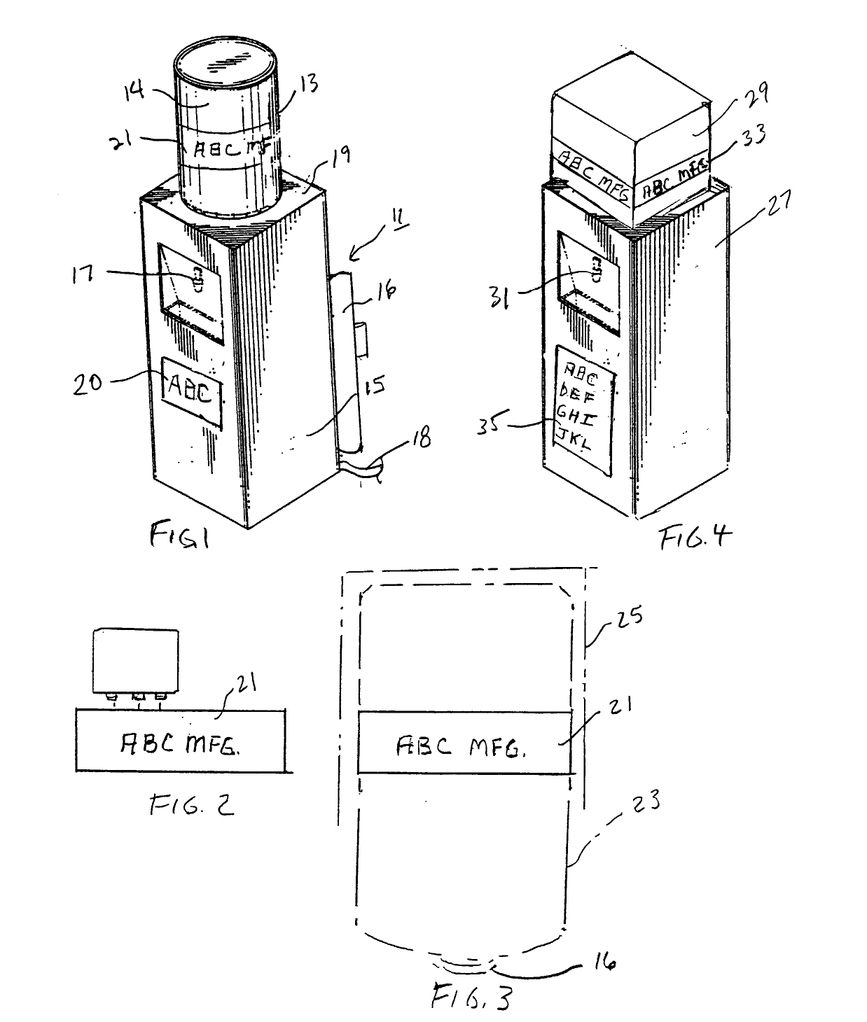

FIG. 1 shows a bottled water dispensing apparatus designated generally as 11. The apparatus 11 includes a bottle 13 and a dispensing stand 15. The particular bottle illustrated has a cylindrical exterior surface 14 and a neck portion (16 in FIG. 3) which forms an outlet spout extending from one end of the bottle. Typical bottle capacities are 3, 5 and 6 gallons, respectively. Other bottle dimensions and shapes may be used, however, without departing from the spirit and scope of the invention.

In the embodiment of the invention illustrated, the bottle is normally fixed to the companion stand 15 in use and includes external filtration equipment 16. A water supply line 18 provides water to the filtration equipment 16 and, in turn, to the fixed bottle 13. A conventional float (not shown) which is located within the bottle interior, introduces additional water as the bottle is emptied in use. In other embodiments of the invention, the filtration equipment may be located within the stand 15 itself or may even be remotely located from the stand, as in a cabinet adjacent the inlet water supply.

A combination fixed bottle/stand apparatus is commercially available in the marketplace from AquaCell Technologies, Inc., of Rancho Cucamonga, Calif., as the “PURIFIC” unit. This apparatus is a five gallon self refilling bottled water cooler which contains different combinations of systems that utilize sediment filters, reverse osmosis, carbon block, multi-media filters and ultra-violet light. This product replaces traditional five gallon bottled water coolers with a permanently installed convenient alternative where the water bottle never needs changing and water bottles no longer need to be delivered, stored or replaced.

The dispensing stand 15 typically contains cooling and heating elements for dispensing water from the bottle 13 through the respective discharge faucet or faucets 17. The water bottle 13 is itself typically maintained at ambient temperature.

The dispensing stand 15 has a top ledge 19 with an opening (not shown) for receiving the neck 16 of the bottle 13 for stably supporting the bottle by reason of gravity. The bottle 13 is received in the position shown in FIG. 1 and is mounted in semi-permanent fashion in normal use. In other words, the bottle would normally only be removed from the stand for maintenance or replacement.

FIGS. 2 and 3 are schematic representations of the steps involved in practicing the method of the invention. The first step of the method involves the application of an advertising message, such as the label “ABC MFG” to a suitable substrate. The substrate could be a plain paper band which would be placed around the exterior of the bottle and adhered in any convenient manner, such as by the use of a suitable adhesive, or even by frictional engagement. A variety of substrates could be utilized including fabrics, paper, plastics and other suitable replaceable materials. On the embodiment of the invention illustrated in FIGS. 2 and 3, the substrate comprises a shrink-wrap plastic material such as polyethylene. In the method illustrated in FIG. 2, the advertising message is applied to the substrate through the use of an ink jet printer. Ink jet printers apply a wide range of ink compositions to selected target surfaces as discreet droplets of ink which form an image on the surface. The droplets can be applied using drop on demand or impulse jet printers in which individual droplets are ejected from individual nozzle orifices in an array of nozzles, the position of the printed droplet on the surface being dictated by the nozzle in the array from which it is ejected. Alternatively, the ink jet printer can be a continuous jet printer in which droplets are formed from a jet of ink issuing from a single nozzle, the droplets being given an electric charge and passing through a deflection field which deflects the flight of the individual droplets away from the straight line path by an amount depending upon the strength of the charge and/or the deflecting field. For convenience herein, the term “ink jet printer” will be used to denote all such types of printers. While ink jet printers offer a convenient method for applying the advertising message to the substrate, it will be understood that other conventional printing methods may be utilized, as well, such as screen printing, stamping or embossing, etc.

In the next step in the method, the shrink wrap plastic material (21 in FIG. 2) is then secured to an exterior surface 23 of the bottle 13.

The shrink-wrap material 21 can be applied to the bottle exterior in any of a number of conventional ways. In a typical in-line shrink wrap packaging procedure, one or more unpackaged items are moved towards a shrink wrap cutting and scaling area by an end-feed conveyor. As the items are moved into the shrink wrap cutting and sealing area, the items are surrounded by center-folded shrink wrap film that has been partly unfolded so that the items can be conveyed into to the partially unfolded center-folded film. When the items have been conveyed into the partially unfolded center-folded film, the items exit the end-feed conveyor and are transferred to an exit conveyor. Typically, the exit conveyer continues conveying the items until the items are moved to the shrink-wrap cutting and sealing area beyond a designated cross-sealing location. At that point, it is typical to stop forward movement of the exit conveyor and use a hot knife system to cut the layers of shrink wrap film and contemporaneously weld or seal the layers of film together at the cut so that the shrink wrap film is wrapped around the item.

After the shrink-wrap film has been cut and sealed, the exit conveyor is again activated. The items are then moved into a shrink tunnel or oven illustrated schematically as 25 in FIG. 3. After each group of items is heated in the shrink tunnel, the shrink-wrap tightens around the item so that the item is securely wrapped.

The cutting and sealing is repeated on a consecutive group of bottles as the bottles are conveyed through the system.

The labeled bottles can then be affixed to the companion stands 15 and delivered to a target group of end users. Preferably, the target group is selected based upon specific market analysis criteria. Thus, the advertising message would be a message specifically appealing to members of the target group. In addition to bearing advertising indicia, the label 21 could contain artwork or other types of esthetically pleasing materials which would not only serve the purpose of advertising but also improve the esthetic appearance of the water bottle itself.

Also, while the substrate material has been described with reference to conventional polyethylene, other materials might be heat shrunk as well. For example, a suitable insulating type wrapper might be utilized. U.S. Pat. No. 4,626,455, to Karabedian, for example, describes a tough, heat shrunk sleeve which can be used to cover a drink bottle. The material utilized is a co extruded multilayer sheet which includes an insulating polystyrene foam layer for the inside of the sleeve next to the bottle. This type material, or other suitable insulating materials, could therefore be utilized in place of the polyethylene substrate described above. In addition to providing an insulating barrier, the label 21 could also structurally reinforce the bottle and help to shield it from scratches or punctures.

The supplier or end user of the bottled water dispenser system can periodically change out the advertising message displayed on the bottle or stand. For example, a water system located in a doctor's office could display different drug treatments in interchangeable fashion.

As shown in FIG. 1, the associated stand 15 can also have a label 20 applied to an exterior surface thereof. The label can be a conventional adhesive backed label or can be supplied in any of a number of alternative commercially available formats.

FIG. 4 illustrates another type of water dispensing apparatus referred to in the industry as a “point of use” water dispensing apparatus or cooler. In this case, the stand 27 continues upwardly to form a contoured top 29 for the apparatus which may serve as a reservoir for the stored water. The stand also features a dispensing faucet 31. In the embodiment of the device illustrated in FIG. 4, the contoured top 29 of the stand has an advertising substrate 33 applied as previously described. In this case, the stand portion 27 of the device also has an electronic display screen 35 of a suitable size to display a complete advertising message. In the embodiment illustrated, the screen 35 is approximately 6 inches×18 inches and displays several lines of a text message.

An invention has been provided with several advantages. The advertising method of the invention utilizes an existing bottled water or point of use water distribution system and provides a convenient advertising medium at little additional cost. The labeling technique not only provides for the transmission of an advertising message to a target group of end users but can also provide a means for improving the esthetic appearance of the water bottle or water dispenser itself. Additionally, by choosing an appropriate labeling substrate, other desirable qualities such as an insulating or reinforcing effect can be provided. The technique is simple to implement and can easily be carried out in a reliable manufacturing process.

While the invention has been shown in only two its forms, it is not thus limited but is susceptible to various changes and modifications without departing from the spirit thereof.

What is claimed is:

1. A method of providing advertising utilizing a bottled water supply apparatus which includes a fixed bottle and companion stand, the method comprising the steps of:
applying an advertising message to an exterior surface of the bottle; and
delivering the combination fixed bottle and companion stand to a target group of end users, the target group being selected based upon specific market analysis criteria.

2. A method of providing advertising utilizing a bottled water supply apparatus which includes a fixed bottle and companion stand, the method comprising the steps of:
applying an advertising message to a substrate;
securing the substrate to an exterior surface of a selected bottle being delivered with the companion stand within the water distribution system; and
delivering the combination fixed bottle and companion stand to a target group of end users, the target group being selected based upon specific market analysis criteria.

3. The method of claim 2, wherein the substrate comprises a shrink-wrap plastic material.

4. The method of claim 2, wherein the substrate comprises an insulating material.

5. The method of claim 2, wherein the substrate forms a structural reinforcement for the water bottle.

6. The method of claim 2, wherein the advertising message is applied to the substrate in a large character ink jet printing process.

7. The method of claim 2, further including the steps of periodically changing out the advertising message on the substrate applied to a selected one of the bottle and companion stand.

8. A method of providing advertising utilizing a bottled water supply apparatus which includes a water bottle and companion stand, the method comprising the steps of:
applying an advertising message to a substrate;
securing the substrate to an exterior surface of the companion stand which is to be delivered with the bottle within the water distribution system;
delivering the water bottle and companion stand to a target group of end users, the target group being selected based upon specific market analysis criteria.

9. The method of claim 8 wherein the substrate comprises a shrink-wrap plastic material.

10. The method of claim 8 wherein a printed label is applied to an exterior surface of the companion stand by means of an adhesive backing on the label.

11. The method of claim 8 wherein the advertising message is applied to the substrate in a large character ink jet printing process.

12. A method of providing advertising utilizing a point of use water supply apparatus which includes a contoured top and companion stand, the method comprising the steps of:
applying an advertising message to a substrate;
securing the substrate to an exterior surface of a selected on of the contoured top and the companion stand which is to be delivered within the water distribution system;
delivering the apparatus to a target group of end users, the target group being selected based upon specific market analysis criteria.

13. The method of claim 12, wherein the water supply apparatus also includes an electronic display screen having a display area large enough to display multiple lines of a text message.
